(19) United States
(12) Patent Application Publication
(10) Pub. No.: US 2011/0214822 A1
(43) Pub. Date: Sep. 8, 2011

(54) WINDOW BLIND ASSEMBLY

(76) Inventor: Shih-Ming LIN, Chiayi Hsien (TW)

(21) Appl. No.: 12/719,046

(22) Filed: Mar. 8, 2010

(51) Int. Cl. E06B 9/24

(52) U.S. Cl. 160/121.1

(57) ABSTRACT

A window blind assembly includes a horizontal frame, a roller rod, two roller blind shade elements, and a holding component. The horizontal frame extends horizontally and is mounted at an upper edge portion of the window. The roller rod extends horizontally, and is mounted to the horizontal frame. Each of the roller blind shade elements has a top edge connected to the roller rod such that the roller blind shade elements are positioned horizontally adjacent to one another with a gap formed therebetween. The roller blind shade elements are able to be wound around and extended from the roller rod as the roller rod rotates. The holding component includes a fastener portion connected to the horizontal frame, and a holding portion connected to the fastener portion and which supports the roller rod at a location corresponding to the gap between the roller blind shade elements.

### BACKGROUND OF THE INVENTION

1. Field of the Invention

The present invention relates to a window blind assembly, more particularly to a window blind assembly that is structurally simple and can cover a window having a significant width.

2. Description of the Related Art

Referring to FIG. 1, a conventional window blind assembly includes a horizontal frame 11 that is mounted at an upper edge portion of a window, a roller rod 12 that extends horizontally, is mounted to the horizontal frame 11, and is operable to rotate about its axis, a roller blind cloth 13 a top edge of which is connected to the roller rod 12, and a cord 14 that is able to drive the roller rod 12 to rotate. The roller blind cloth 13 may be wound around and unwound from the roller rod 12 by pulling the cord 14 such that the roller rod 12 is rotated, thereby either covering or uncovering the window.

However, different windows have different dimensions. When a window has asignificant width, or a plurality of windows share a single window blind assembly, the lengths of the horizontal frame 11 and the roller rod 12 need to be increased, and the width of the roller blind cloth 13 also needs to be increased.

The roller rod 12 is mounted to the horizontal frame 11 using only the two ends of the roller rod 12. When the roller rod 12 is increased in length and the roller blind cloth 13 is made correspondingly larger, the increased weight results in sagging of the roller rod 12, as shown by the dotted lines in FIG. 1. As a result, creases will be formed in the roller blind cloth 13, thereby negatively affecting the overall appearance of the window blind assembly.

Although the thickness of the roller rod 12 can be increased to avoid such sagging thereof, the thicker roller rod 12 may also affect the appearance of the window blind assembly. Furthermore, the thicker roller rod 12 requires more material and therefore the cost of the window blind assembly is increased.

### SUMMARY OF THE INVENTION

Therefore, the object of the present invention is to provide a window blind assembly, in which a roller rod thereof is prevented from being bent.

Accordingly, a window blind assembly of the present invention is adapted for being mounted to a window. The window blind assembly comprises a horizontal frame, a roller rod, two roller blind shade elements, and a holding component.

The horizontal frame extends horizontally and is mounted at or in proximity to an upper edge portion of the window.

The roller rod extends horizontally, is mounted to the horizontal frame, and is operable to rotate about its axis.

Each of the roller blind shade elements has a top edge connected to the roller rod such that the roller blind shade elements are positioned horizontally adjacent to one another with a gap formed therebetween. The roller blind shade elements are able to be wound around and extended from the roller rod as the roller rod rotates.

The holding component includes a fastener portion that is connected to the horizontal frame, and a holding portion connected to the fastener portion and which supports the roller rod at a location corresponding to the gap between the roller blind shade elements.

### BRIEF DESCRIPTION OF THE DRAWINGS

Other features and advantages of the present invention will become apparent in the following detailed description of the preferred embodiments with reference to the accompanying drawings, of which:

FIG. 1 is a rear view of a conventional window blind assembly;

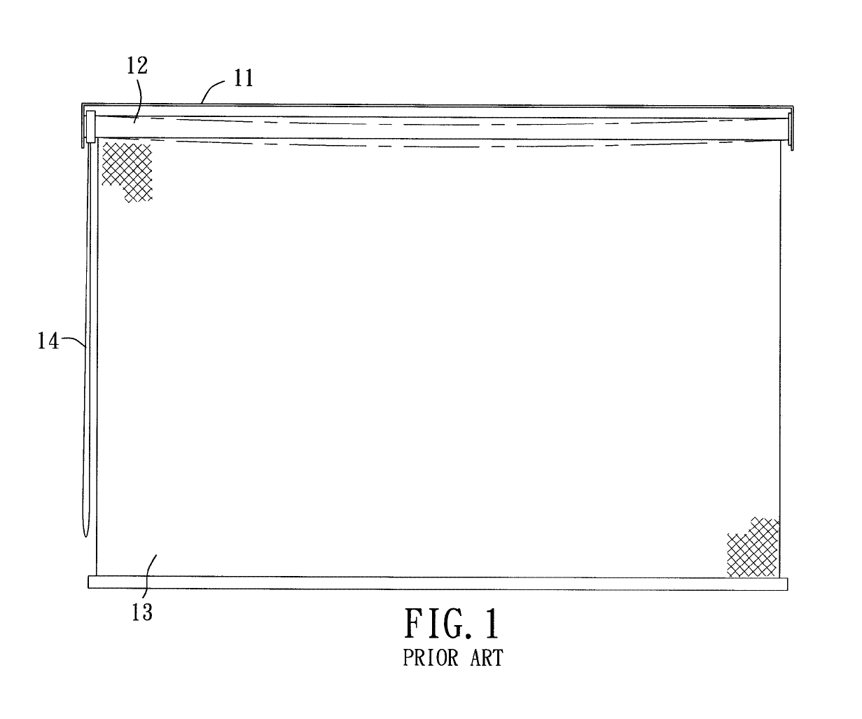

FIG. 2 is a rear view of a window blind assembly according to a first preferred embodiment of the present invention;

FIG. 3 is an exploded perspective view of the window blind assembly of the first preferred embodiment;

FIG. 4 is a fragmentary rear view of the window blind assembly of the first preferred embodiment;

FIG. 5 is an exploded perspective view of a window blind assembly according to a second preferred embodiment of the present invention; and

FIG. 6 is an exploded perspective view of a window blind assembly according to a third preferred embodiment of the present invention.

### DETAILED DESCRIPTION OF THE PREFERRED EMBODIMENTS

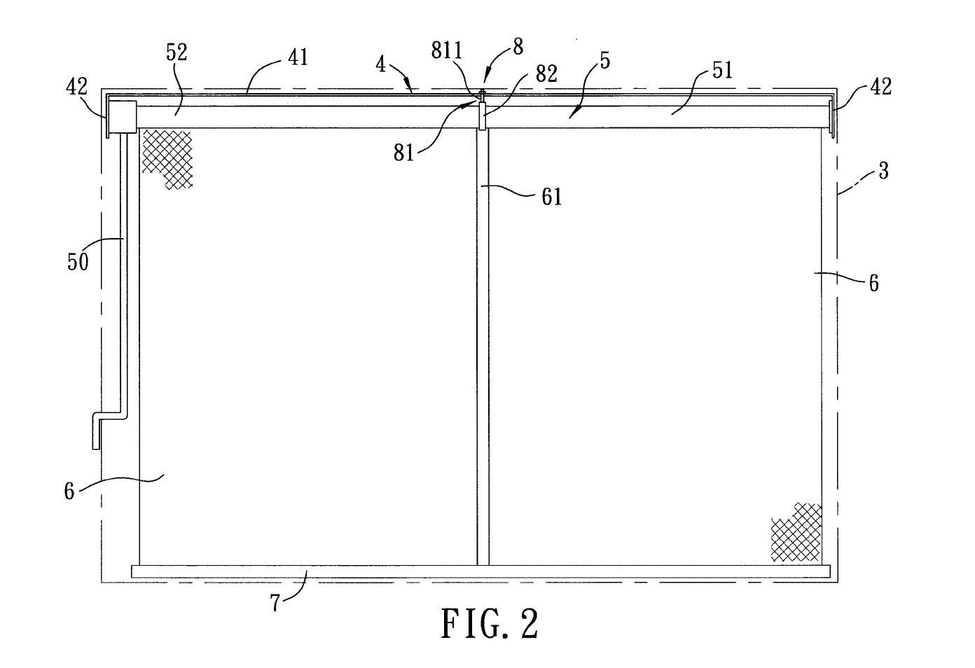

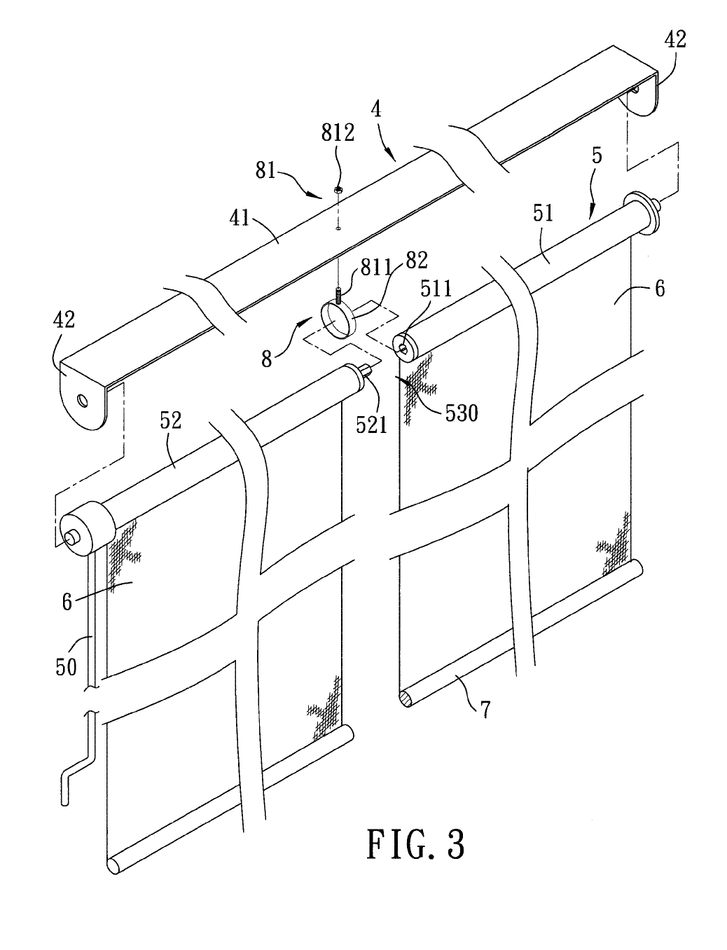

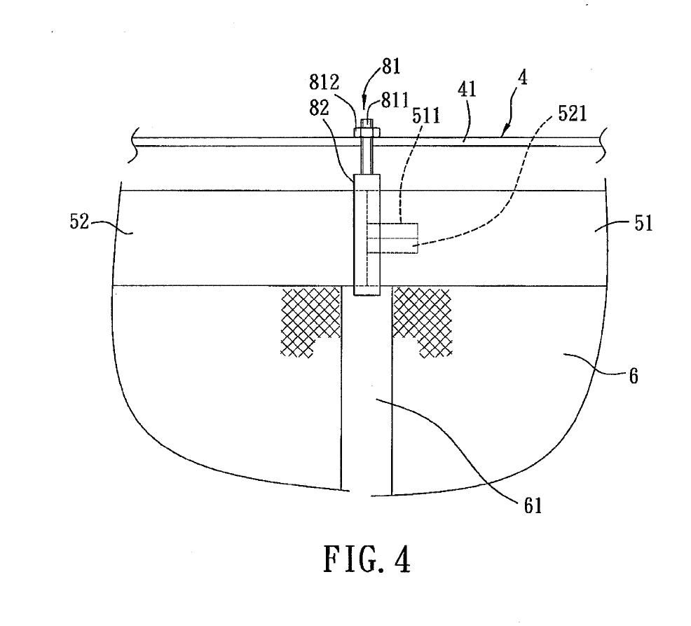

Referring to FIGS. 2, 3 and 4, a first preferred embodiment of a window blind assembly of the present invention is adapted for being mounted to a window 3. The window blind assembly includes a horizontal frame 4, a roller rod 5, two roller blind shade elements 6, a weighting rod 7, and a holding component 8.

The horizontal frame 4 extends horizontally and includes a top plate 41 and two side plates 42. The top plate 41 of the horizontal frame 4 extends horizontally, and is mounted at or in proximity to an upper edge portion of the window 3. The side plates 42 of the horizontal frame 4 are connected respectively to two ends of the top plate 41. In this embodiment, the side plates 42 extend downwardly from the top plate 41 in a direction substantially perpendicular to the top plate 41.

The roller rod 5 extends horizontally. Two ends of the roller rod 5 are respectively mounted to the side plates 42 of the horizontal frame 4. The roller rod 5 is operable to rotate about its axis.

In this embodiment, the roller rod 5 includes a first rod portion 51, and a second rod portion 52 connected axially to the first rod portion 51. Each of the first and second rod portions 51, 52 has an outer end and an inner end. The outer ends of the first and second rod portions 51, 52 are connected respectively to the side plates 42 of the horizontal frame 4, and the inner ends thereof are connected to each other. The inner end of the first rod portion 51 has a hole-forming wall that defines a non-circular inserting groove 511. The inner end of the second rod portion 52 has a protrusion 521 inserted into and corresponding in shape to the inserting groove 511. In this embodiment, the roller rod 5 is driven by a winding rod 50 to rotate, or may be driven by a motor. Thus, the driving method is not limited thereto.

The roller blind shade elements 6 have two top edges connected respectively to the first and second rod portions 51, 52 of the roller rod 5 in such a manner that the roller blind shade elements 6 are positioned horizontally adjacent to one another with a gap 61 formed therebetween. The roller blind shade elements 6 are able to be wound around and extended from the roller rod 5 as the roller rod 5 rotates.

The weighting rod 7 extends horizontally, and is connected to bottom edges of the roller blind shade elements 6. The weighting rod 7 pulls down on the roller blind shade elements 6 to flatten the same by virtue of its weight.

The holding component 8 includes a fastener portion 81 and a holding portion 82. A top end of the fastener portion 81 of the holding component 8 is connected to the top plate 41 of the horizontal frame 4. The holding portion 82 of the holding component 8 is connected to a bottom end of the fastener portion 81, and supports the roller rod 5 at a location corresponding to the gap 61 between the roller blind shade elements 6. In this embodiment, the location corresponding to the gap 61 also corresponds to where the first rod portion 51 and the second rod portion 52 are connected. In this embodiment, the fastener portion 81 includes a bolt 811 that extends through the top plate 41 of the horizontal frame 4, and a nut 812 engaged with the bolt 811. Moreover, in this embodiment, the holding portion 82 of the holding component 8 is in the form of a ring and is loosely sleeved on the roller rod 5, such that the holding portion 82 does not hinder rotation of the roller rod 5.

Moreover, in this and other embodiments of this invention, the portion of the roller rod 5 where the first and second rod portions 51, 52 are connected to each other may have a smaller diameter than the remainder of the roller rod 5 to thereby form a track 530 for receiving the holding portion 82 of the holding component 8. This ensures that the holding portion 82 of the holding component 8 remains at this portion of the roller rod 5 and allows for smooth rotation of the roller rod 5.

The roller blind shade elements 6 when in use can cover a window 3 having a wider width or a plurality of windows 3 by rotating the roller rod 5 to wind or unwind the roller blind shade elements 6. In addition, the fastener portion 81 is connected to the top plate 41, and the holding portion 82 supports the roller rod 5, such that sagging of the roller rod 5 due to the combined weight of the roller rod 5 itself and the roller blind shade elements 6 can be avoided. Hence, the roller blind shade elements 6 will not wrinkle or crease as a result of bending of the roller rod 5. Also, it is not necessary to increase the thickness of the roller rod 5 in an effort to prevent such sagging of the same, thereby reducing costs and maintaining the overall aesthetics of the window blind assembly.

Furthermore, because the roller rod 5 includes the first rod portion 51 and the second rod portion 52, the roller rod 5 is easily disassembled and fabricated, reducing manufacturing, packing, and shipping costs. Additionally, the roller rod 5 is easily mounted to the horizontal frame 4 by interconnecting the first rod portion 51 and the second rod portion 52, thereby simplifying the assembly process of the window blind assembly of the present invention.

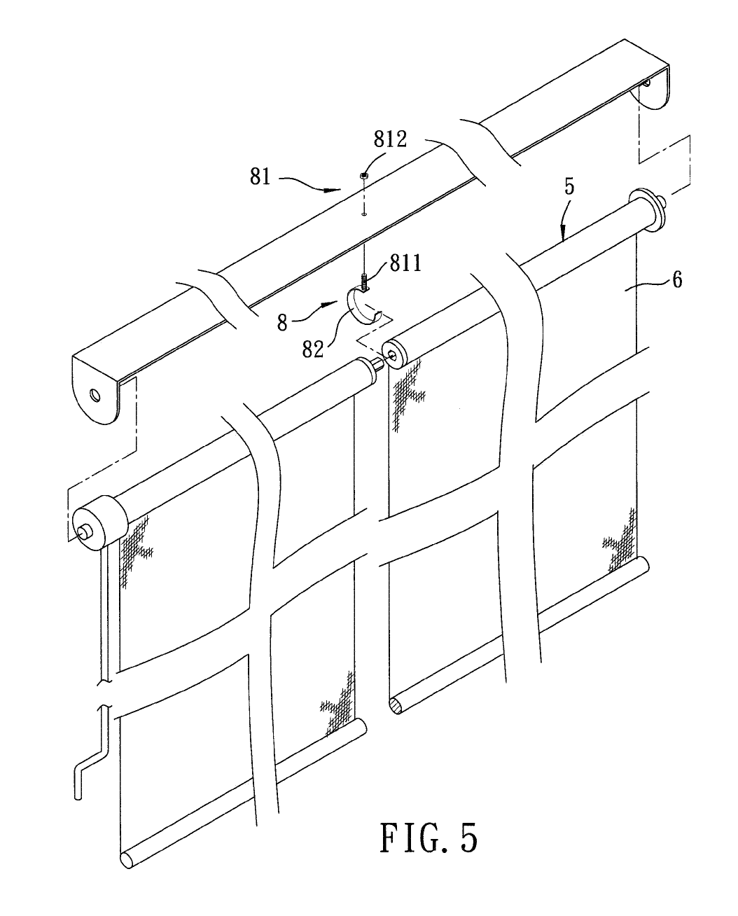

FIG. 5 illustrates a second preferred embodiment of the window blind assembly according to the present invention. The second preferred embodiment differs from the first preferred embodiment in the following aspects.

The holding portion 82 of the holding component 8 is C-shaped, and is loosely sleeved on the roller rod 5, such that the holding portion 82 does not hinder rotation of the roller rod 5.

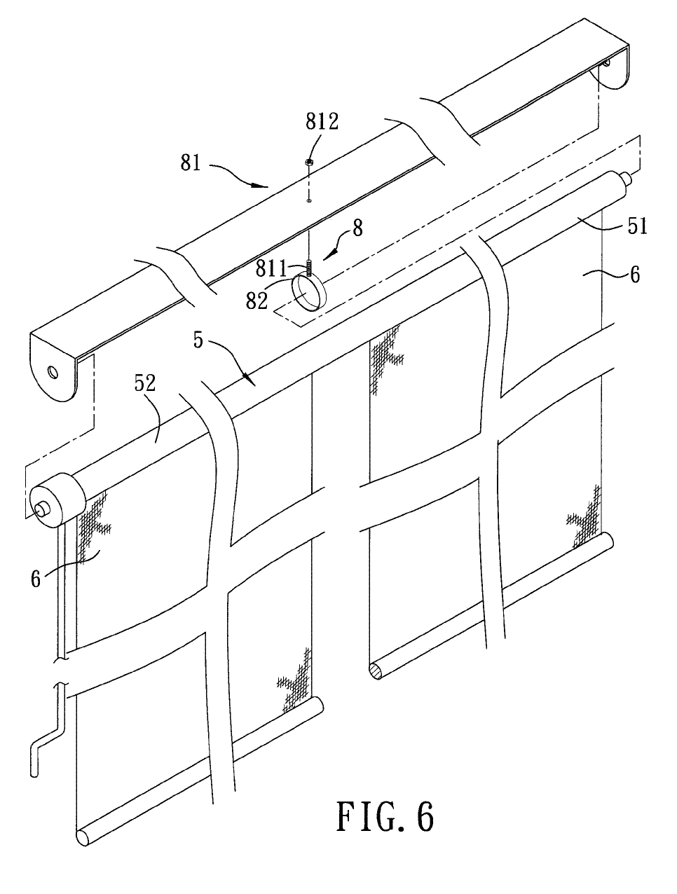

FIG. 6 illustrates a third preferred embodiment of the window blind assembly according to the present invention. The third preferred embodiment differs from the first preferred embodiment in the following aspects.

The roller rod 5 is a single piece, that is to say, the first rod portion 51 and the second rod portion 52 are configured as a single piece forming the roller rod 5, and therefore cannot be disassembled. The holding portion 82 supports the roller rod 5 to avoid bending of the roller rod 5 and therefore wrinkling of the roller blind shade elements 6.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A window blind assembly adapted for being mounted to a window, said window blind assembly comprising:
a horizontal frame that extends horizontally and is mounted at or in proximity to an upper edge portion of the window;
a roller rod that extends horizontally, is mounted to said horizontal frame, and is operable to rotate about its axis;
two roller blind shade elements, each having a top edge connected to said roller rod in such a manner that said roller blind shade elements are positioned horizontally adjacent to one another with a gap formed therebetween, said roller blind shade elements being able to be wound around and extended from said roller rod as said roller rod rotates; and
a holding component that includes a fastener portion that is connected to said horizontal frame, and a holding portion connected to said fastener portion and which supports said roller rod at a location corresponding to the gap between said roller blind shade elements.

2. The window blind assembly as claimed in claim 1, wherein said roller rod includes a first rod portion and a second rod portion connected to said first rod portion, said roller blind shade elements being connected respectively to said first and second rod portions.

3. The window blind assembly as claimed in claim 2, wherein each of said first and second rod portions has an outer end and an inner end, said outer ends being connected to said horizontal frame and said inner ends being connected to each other, said inner end of said first rod portion having a hole-forming wall that defines a non-circular inserting groove, said inner end of said second rod portion having a protrusion inserted into and corresponding in shape to said inserting groove.

4. The window blind assembly as claimed in claim 2, wherein said holding portion of said holding component supports said roller rod at a location where said first rod portion and said second rod portion are connected.

5. The window blind assembly as claimed in claim 1, wherein said holding portion of said holding component is in the form of a ring and is loosely sleeved on said roller rod, such that said holding portion does not hinder rotation of said roller rod.

6. The window blind assembly as claimed in claim 1, wherein said holding portion of said holding component is C-shaped and is loosely sleeved on said roller rod, such that said holding portion does not hinder rotation of said roller rod.

7. The window blind assembly as claimed in claim 1, wherein a top end of said fastener portion of said holding component is connected to said horizontal frame, and said holding portion of said holding component is connected to a bottom end of said fastener portion.

8. The window blind assembly as claimed in claim 7, wherein said fastener portion includes a bolt that extends through said horizontal frame, and a nut engaged with said bolt.
